(19) United States
(12) Patent Application Publication
(10) Pub. No.: US 2026/0249707 A1
(43) Pub. Date: Aug. 27, 2026

(54) SLIP-STATE DETERMINATION METHOD, STUCK-STATE DETERMINATION METHOD, STORAGE MEDIUM, SLIP-STATE DETERMINATION DEVICE, AND STUCK-STATE DETERMINATION DEVICE

(71) Applicant: HONDA MOTOR CO., LTD., Tokyo (JP)

(72) Inventors: Takaaki Nishida, Wako-shi (JP); Shota Tanabe, Tokyo (JP)

(21) Appl. No.: 19/543,923

(22) Filed: Feb. 19, 2026

(30) Foreign Application Priority Data
Feb. 25, 2025 (JP) 2025-027747

(51) Int. Cl. B60L 15/20; A01D 69/02; A01D 34/66; A01D 101/00

(52) U.S. Cl. CPC B60L 15/20; A01D 69/02; A01D 34/66; A01D 2101/00; B60L 2200/40; B60L 2240/465

(57) ABSTRACT

A slip-state determination method is a method for determining a slip state of a drive wheel provided in an electric riding lawn mower and driven by a drive motor. The method includes: acquiring, as an actual yaw rate, a yaw rate of the electric riding lawn mower, using an inertial measurement unit; calculating, as a calculated yaw rate, the yaw rate of the electric riding lawn mower, based on a wheel speed of the drive wheel; and determining whether or not the drive wheel is in the slip state, based on a comparison between the actual yaw rate and a first threshold value and a comparison between the calculated yaw rate and a second threshold value.

### CROSS-REFERENCE TO RELATED APPLICATIONS

This application is based upon and claims the benefit of priority from Japanese Patent Application No. 2025-027747 filed on February 25, 2025, the contents of which are incorporated herein by reference.

### BACKGROUND OF THE INVENTION

### FIELD OF THE INVENTION

The present disclosure relates to a slip-state determination method, a stuck-state determination method, a storage medium, a slip-state determination device, and a stuck-state determination device.

### DESCRIPTION OF THE RELATED ART

JP 2017-085814 A discloses an electric work vehicle. In the electric work vehicle, the slip of the drive wheels is determined by comparing an actual yaw rate detected by a yaw rate detector with an arithmetic yaw rate obtained from the rotating speeds of the left and right drive wheels.

### SUMMARY OF THE INVENTION

A more excellent slip-state determination method or the like is desired.

The present disclosure has the object of satisfying the aforementioned need.

A first aspect of the present disclosure is a slip-state determination method for determining a slip state of a drive wheel provided in a mobile working machine and which is driven by a drive motor, the method including: acquiring a yaw rate of the mobile working machine, as an actual yaw rate, by using a yaw rate detection unit; calculating the yaw rate of the mobile working machine, as a calculated yaw rate, based on a wheel speed of the drive wheel; and determining whether or not the drive wheel is in the slip state, based on a comparison between the actual yaw rate and a first threshold value and a comparison between the calculated yaw rate and a second threshold value.

A second aspect of the present disclosure is a stuck-state determination method for determining a stuck state of a mobile working machine including a drive wheel driven by a drive motor, the method including: acquiring a yaw rate of the mobile working machine, as an actual yaw rate, by using a yaw rate detection unit; calculating the yaw rate of the mobile working machine, as a calculated yaw rate, based on a wheel speed of the drive wheel; measuring a duration time, the duration time being a time period during which a state in which an absolute value of the actual yaw rate is less than a first threshold value and an absolute value of the calculated yaw rate is equal to or greater than a second threshold value continues; and determining whether or not the mobile working machine is in the stuck state, based on a comparison between the duration time and a fifth threshold value.

A third aspect of the present disclosure is a program that causes a computer to execute a slip-state determination method for determining a slip state of a drive wheel provided in a mobile working machine and which is driven by a drive motor, the program causing the computer to: acquire a yaw rate of the mobile working machine, as an actual yaw rate, by using a yaw rate detection unit; calculate the yaw rate of the mobile working machine, as a calculated yaw rate, based on a wheel speed of the drive wheel; and determine whether or not the drive wheel is in the slip state, based on a comparison between the actual yaw rate and a first threshold value and a comparison between the calculated yaw rate and a second threshold value.

A fourth aspect of the present disclosure is a program that causes a computer to execute a stuck-state determination method for determining a stuck state of a mobile working machine including a drive wheel driven by a drive motor, the program causing the computer to: acquire a yaw rate of the mobile working machine, as an actual yaw rate, by using a yaw rate detection unit; calculate the yaw rate of the mobile working machine, as a calculated yaw rate, based on a wheel speed of the drive wheel; measure a duration time, the duration time being a time period during which a state in which an absolute value of the actual yaw rate is less than a first threshold value and an absolute value of the calculated yaw rate is equal to or greater than a second threshold value continues; and determine whether or not the mobile working machine is in the stuck state, based on a comparison between the duration time and a fifth threshold value.

A fifth aspect of the present disclosure is a computer-readable non-transitory storage medium storing the program according to the third aspect or the fourth aspect.

A sixth aspect of the present disclosure is a slip-state determination device that determines a slip state of a drive wheel provided in a mobile working machine and which is driven by a drive motor, the slip-state determination device including: an actual yaw rate acquisition unit configured to acquire a yaw rate of the mobile working machine, as an actual yaw rate, by using a yaw rate detection unit; a yaw rate calculation unit configured to calculate the yaw rate of the mobile working machine, as a calculated yaw rate, based on a wheel speed of the drive wheel; and a determination unit configured to determine whether or not the drive wheel is in the slip state, based on a comparison between an absolute value of the actual yaw rate and a first threshold value and a comparison between an absolute value of the calculated yaw rate and a second threshold value.

A seventh aspect of the present disclosure is a stuck- state determination device for determining a stuck state of a mobile working machine including a drive wheel driven by a drive motor, the stuck-state determination device including: an actual yaw rate acquisition unit configured to acquire a yaw rate of the mobile working machine, as an actual yaw rate, by using a yaw rate detection unit; a yaw rate calculation unit configured to calculate the yaw rate of the mobile working machine, as a calculated yaw rate, based on a wheel speed of the drive wheel; and a determination unit configured to measure a duration time which is a time period during which a state in which an absolute value of the actual yaw rate is less than a first threshold value and an absolute value of the calculated yaw rate is equal to or greater than a second threshold value continues, and determine whether or not the mobile working machine is in the stuck state, based on a comparison between the duration time and a fifth threshold value.

According to the present disclosure, a more favorable slip-state determination method and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of an electric riding lawn mower;

FIG. 2 is a block diagram of a vehicle control device;

FIG. 3 is a flowchart of determination control executed in the vehicle control device; and

FIG. 4 is a flowchart of drive control executed in the vehicle control device.

### DETAILED DESCRIPTION OF THE INVENTION

### Embodiment

### Configuration of Vehicle

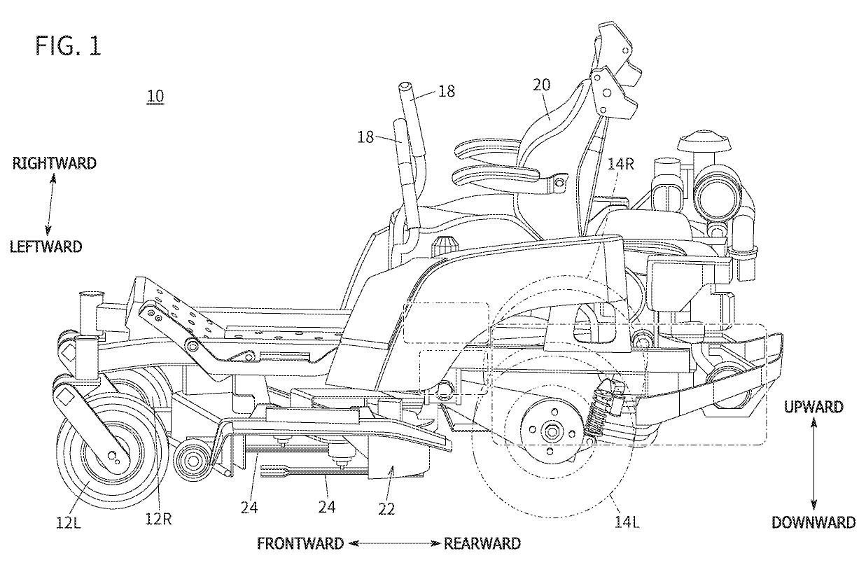

FIG. 1 is a perspective view of an electric riding lawn mower 10. The electric riding lawn mower 10 corresponds to a mobile working machine of the present invention. The mobile working machine of the present invention is not limited to the electric riding lawn mower 10. The mobile working machine of the present invention may include an engine as a drive source instead of the electric motor. The mobile working machine of the present invention is not limited to a riding lawn mower. The mobile working machine of the present invention may be, for example, an unmanned lawn mower. The mobile working machine of the present invention is not limited to a lawn mower. The mobile working machine of the present invention may be, for example, a snow removal machine.

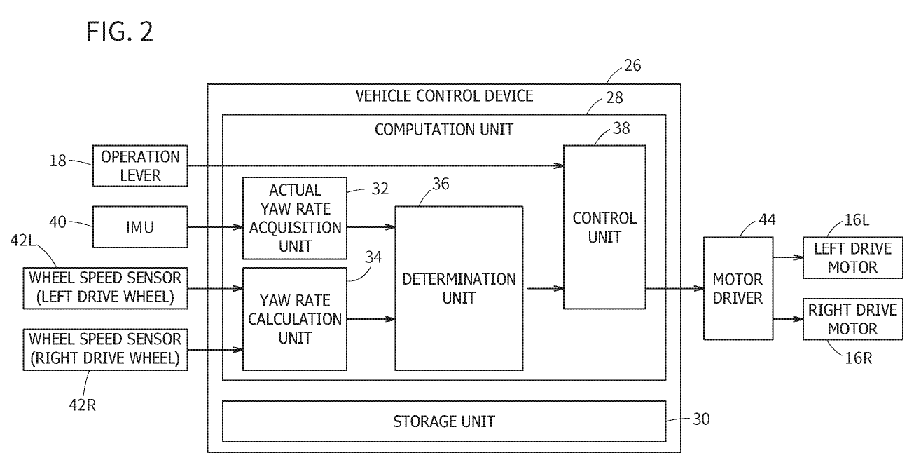

The electric riding lawn mower 10 includes a left front wheel 12L, a right front wheel 12R, a left drive wheel 14L as a left rear wheel, and a right drive wheel 14R as a right rear wheel. The left front wheel 12L and the right front wheel 12R are caster wheels, and the directions thereof can be changed as needed. The left drive wheel 14L is driven by a left drive motor 16L (FIG. 2), and the right drive wheel 14R is driven by a right drive motor 16R (FIG. 2). The electric riding lawn mower 10 does not have any steered wheels, and instead can perform a pivot turn (zero turn) by using a difference in wheel speed between the left drive wheel 14L and the right drive wheel 14R. The electric riding lawn mower 10 is also referred to as a "zero turn-radius mower". The electric riding lawn mower 10 may be capable of performing a counter-rotation turn. The pivot turn means that the electric riding lawn mower 10 turns about one of the left and right sides of the electric riding lawn mower 10, and the counter-rotation turn means that the electric riding lawn mower 10 turns about the center of the electric riding lawn mower 10. The electric riding lawn mower 10 may have steered wheels. The left drive wheel 14L and the right drive wheel 14R may be driven by one drive motor.

The electric riding lawn mower 10 includes a pair of left and right operation levers 18 and a seat 20. A user (not shown) sits on the seat 20 and operates the operation levers 18. The electric riding lawn mower 10 moves forward, backward, and turns by operating the operation levers 18. When the electric riding lawn mower 10 includes steered wheels, the electric riding lawn mower 10 may include a steering wheel or handlebars for operating the steered wheels.

The electric riding lawn mower 10 may be automatically operated without the user riding on the electric riding lawn mower 10. The user may operate the electric riding lawn mower 10 to thereby perform teaching of a lawn mowing work, and then the electric riding lawn mower 10 may perform automatic operation based on the content of the teaching. When the electric riding lawn mower 10 performs automatic operation, a signal of the amount of operation of each operation lever 18 is sent to a vehicle control device 26 (described later) by an operation management device (not shown).

The electric riding lawn mower 10 includes a lawn mower deck 22. The lawn mower deck 22 is provided with a plurality of blades 24. The rotation of the blades 24 causes lawns to be mowed.

### Configuration of Vehicle Control Device

FIG. 2 is a block diagram of the vehicle control device 26. The vehicle control device 26 is mounted on the electric riding lawn mower 10 and controls the electric riding lawn mower 10. The vehicle control device 26 corresponds to a slip-state determination device and a stuck-state determination device of the present invention.

The vehicle control device 26 includes a computation unit 28 and a storage unit 30.

The computation unit 28 is, for example, a processor such as a central processing unit (CPU), a graphics processing unit (GPU), or the like. The computation unit 28 includes an actual yaw rate acquisition unit 32, a yaw rate calculation unit 34, a determination unit 36, and a control unit 38. The actual yaw rate acquisition unit 32, the yaw rate calculation unit 34, the determination unit 36, and the control unit 38 are realized by the computation unit 28 executing programs stored in the storage unit 30. At least a part of the actual yaw rate acquisition unit 32, the yaw rate calculation unit 34, the determination unit 36, and the control unit 38 may be realized by an integrated circuit such as an application specific integrated circuit (ASIC) or a field-programmable gate array (FPGA). At least a part of the actual yaw rate acquisition unit 32, the yaw rate calculation unit 34, the determination unit 36, and the control unit 38 may be realized by an electronic circuit including a discrete device.

The storage unit 30 is configured by a volatile memory (not illustrated) and a nonvolatile memory (not illustrated) which are computer-readable storage medium. The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the nonvolatile memory. At least a part of the storage unit 30 may be included in the processor, the integrated circuit, or the like described above. At least a part of the storage unit 30 may be mounted on a device connected to the electric riding lawn mower 10 via a network.

The actual yaw rate acquisition unit 32 acquires an actual yaw rate at which the electric riding lawn mower 10 turns (i.e., the actual yaw rate of the electric riding lawn mower 10). The actual yaw rate is measured by an inertial measurement unit (IMU) 40 mounted on the electric riding lawn mower 10.

The yaw rate calculation unit 34 calculates, as a calculated yaw rate, a yaw rate of the electric riding lawn mower 10, based on the wheel speed of the left drive wheel 14L and the wheel speed of the right drive wheel 14R. The wheel speed of the left drive wheel 14L is detected by a wheel speed sensor 42L of the left drive wheel 14L mounted on the electric riding lawn mower 10. The wheel speed of the right drive wheel 14R is detected by a wheel speed sensor 42R of the right drive wheel 14R mounted on the electric riding lawn mower 10.

In the electric riding lawn mower 10 of an embodiment, the left drive wheel 14L and the left drive motor 16L are directly connected to each other, and the rotation speed of the left drive motor 16L is the same as the rotation speed of the left drive wheel 14L. Therefore, the rotational

speed of the left drive motor 16L may be used as the wheel speed of the left drive wheel 14L. When a transmission is provided between the left drive wheel 14L and the left drive motor 16L, the rotational speed of the left drive motor 16L may be converted into the wheel speed of the left drive wheel 14L based on the gear ratio. The rotational speed of the left drive motor 16L may be detected by a motor driver 44 that drives the left drive motor 16L.

In the electric riding lawn mower 10 of the embodiment, the right drive wheel 14R and the right drive motor 16R are directly connected to each other, and the rotational speed of the right drive motor 16R is the same as the rotational speed of the right drive wheel 14R. Therefore, the rotational speed of the right drive motor 16R may be used as the wheel speed of the right drive wheel 14R. When a transmission is provided between the right drive wheel 14R and the right drive motor 16R, the rotation speed of the right drive motor 16R may be converted into the wheel speed of the right drive wheel 14R based on the gear ratio. The rotational speed of the right drive motor 16R may be detected by the motor driver 44 that drives the right drive motor 16R.

The determination unit 36 determines whether the left drive wheel 14L or the right drive wheel 14R is in a slip state or not, based on the comparison between the actual yaw rate and a first threshold value and the comparison between the calculated yaw rate and a second threshold value. Further, the determination unit 36 determines whether the electric riding lawn mower 10 is in a stuck state, based on a duration time (hereinafter, referred to as a slip duration time) during which the slip state of the left drive wheel 14L or the right drive wheel 14R continues. These determinations will be described in detail later.

The "slip" in the present disclosure does not refer to a "braking slip" that occurs when a braking force acts on the left drive wheel 14L or the right drive wheel 14R, but refers to an "acceleration slip" that occurs when a drive force acts on the left drive wheel 14L or the right drive wheel 14R. In addition, the "slip" in the present disclosure indicates a slip that has a degree of slip exceeding a predetermined level, of the "acceleration slips". The term "slip" as used herein refers to a state in which the left drive wheel 14L or the right drive wheel 14R (wheel) is rotating but the electric riding lawn mower 10 (vehicle body) is not moving.

The term "stuck" as used herein refers to a state in which the degree of slip due to the "acceleration slippage" is large and the electric riding lawn mower 10 cannot move even though the left drive wheel 14L or the right drive wheel 14R is rotating.

The control unit 38 performs drive control on the motor driver 44 that drives the left drive motor 16L and the right drive motor 16R, based on the determination result in the determination unit 36. The drive control will be described in detail later.

### Determination Control

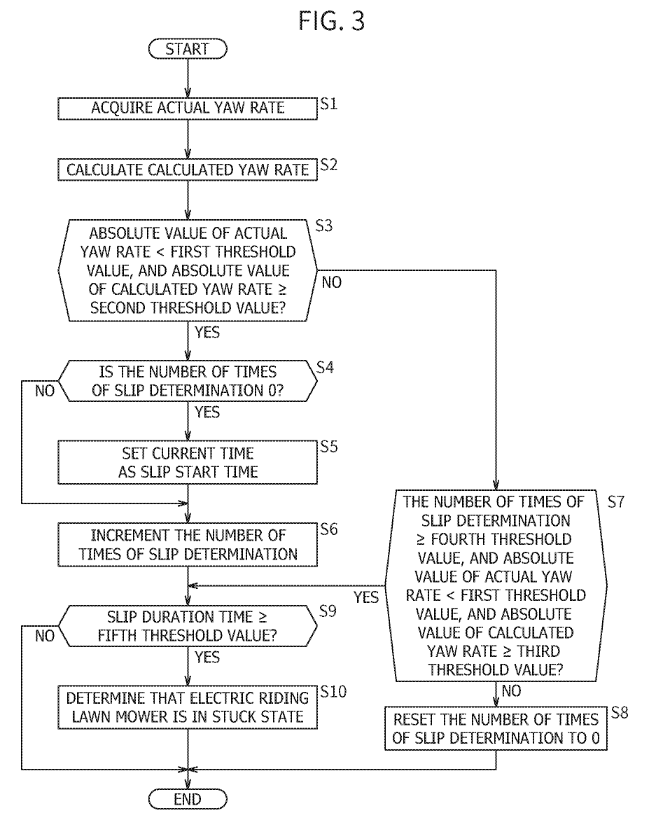

FIG. 3 is a flowchart of the determination control executed in the vehicle control device 26. The determination control is repeatedly executed at predetermined time intervals.

In step S1, the actual yaw rate acquisition unit 32 acquires the actual yaw rate. Thereafter, the process proceeds to step S2.

In step S2, the yaw rate calculation unit 34 calculates the calculated yaw rate. Thereafter, the process proceeds to step S3.

In step S3, the determination unit 36 determines whether or not the absolute value of the actual yaw rate is less than a first threshold value and whether or not the absolute value of the calculated yaw rate is equal to or greater than a second threshold value. When the absolute value of the actual yaw rate is less than the first threshold value and the absolute value of the calculated yaw rate is equal to or greater than the second threshold value (step S3: YES), the determination unit 36 determines that the left drive wheel 14L or the right drive wheel 14R is in the slip state. The left drive wheel 14L or the right drive wheel 14R being in the slip state indicates a state in which the wheel speed of the left drive wheel 14L or the right drive wheel 14R is higher than the vehicle body speed of the electric riding lawn mower 10 by a predetermined value or more.

When the electric riding lawn mower 10 is performing lawn mowing work, the time for traveling straight is relatively short, and the time for turning is relatively long. When the absolute value of the actual yaw rate is less than the first threshold value, it can be determined that the electric riding lawn mower 10 (vehicle body) is not moving. When the absolute value of the calculated yaw rate is equal to or greater than the second threshold value, it can be determined that the left drive wheel 14L or the right drive wheel 14R (wheel) is rotating.

When it is determined that the absolute value of the actual yaw rate is less than the first threshold value and the absolute value of the calculated yaw rate is equal to or greater than the second threshold value (step S3: YES), the process proceeds to step S4. When it is determined that the absolute value of the actual yaw rate is equal to or greater than the first threshold value or the absolute value of the calculated yaw rate is less than the second threshold value (step S3: NO), the process proceeds to step S7.

In step S4, it is determined whether or not the number of times that the left drive wheel 14L or the right drive wheel 14R is determined to be in the slip state (hereinafter referred to as the number of times of slip determination) is 0. When it is determined that the number of times of slip determination is 0 (step S4: YES), the process proceeds to step S5. When it is determined that the number of times of slip determination is not 0 (step S4: NO), the process proceeds to step S6.

In step S5, the determination unit 36 sets the current time as the slip start time. Thereafter, the process proceeds to step S6. The determination unit 36 measures, as a slip duration time, a time period during which the left drive wheel 14L or the right drive wheel 14R is determined to be in the slip state, with the slip start time as a starting point.

In step S6, the determination unit 36 increments the number of times of slip determination by one. Thereafter, the process proceeds to step S9.

As described above, the determination control is repeatedly executed at predetermined time intervals, and it is determined whether or not the left drive wheel 14L or the right drive wheel 14R is in the slip state each time the determination control is executed. Therefore, in step S3 of the determination control which is periodically repeated, each time it is determined that the absolute value of the actual yaw rate is less than the first threshold value and the absolute value of the calculated yaw rate is equal to or greater than the second threshold value, the number of times of slip determination is incremented by one in step S6, and the number of times of slip determination is increased.

In step S7, the determination unit 36 determines whether or not the number of times of slip determination is equal to or greater than a fourth threshold value, whether or not the absolute value of the actual yaw rate is less than the first threshold value, and whether or not the absolute value of the calculated yaw rate is equal to or greater than a third threshold value. The third threshold value is set to a value smaller than the second threshold value.

When the number of times of slip determination is equal to or greater than the fourth threshold value, the absolute value of the actual yaw rate is less than the first threshold value, and the absolute value of the calculated yaw rate is equal to or greater than the third threshold value (step S7: YES), the determination unit 36 determines that the slip state of the left drive wheel 14L or the right drive wheel 14R is continuing. When it is determined that the slip state of the left drive wheel 14L or the right drive wheel 14R is still continuing, the measurement of the slip duration time is continuing.

As described above, when the absolute value of the actual yaw rate is less than the first threshold value, it can be determined that the electric riding lawn mower 10 (vehicle body) is not moving. When the absolute value of the calculated yaw rate is equal to or greater than the third threshold value, it can be determined that the left drive wheel 14L or the right drive wheel 14R (wheel) is rotating.

When it is determined that the number of times of slip determination is equal to or greater than the fourth threshold value, the absolute value of the actual yaw rate is less than the first threshold value, and the absolute value of the calculated yaw rate is equal to or greater than the third threshold value (step S7: YES), the process proceeds to step S9. When it is determined that the number of times of slip determination is less than the fourth threshold value, the absolute value of the actual yaw rate is equal to or greater than the first threshold value, or the absolute value of the calculated yaw rate is less than the third threshold value (step S7: NO), the process proceeds to step S8.

In step S8, the determination unit 36 resets the number of times of slip determination to 0. Thereafter, the determination control is terminated.

In step S9, it is determined whether or not the slip duration time is equal to or greater than a fifth threshold value. When it is determined that the slip duration time is equal to or greater than the fifth threshold value (step S9: YES), the process proceeds to step S10. When it is determined that the slip duration time is less than the fifth threshold value (step S9: NO), the determination control is terminated.

In step S10, the determination unit 36 determines that the electric riding lawn mower 10 is in the stuck state. Thereafter, the determination control is terminated.

### Drive Control

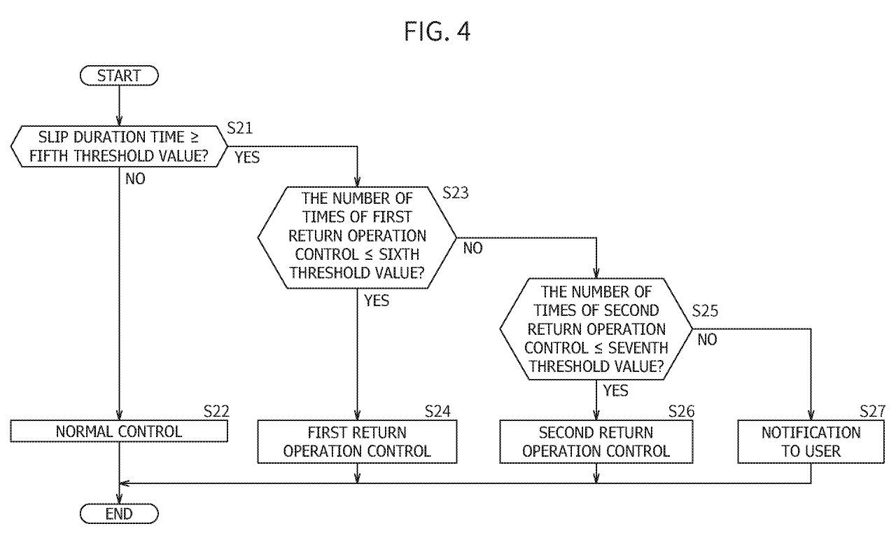

FIG. 4 is a flowchart of the drive control executed in the vehicle control device 26. The drive control is repeatedly executed at predetermined time intervals.

In the drive control, a normal control, a first return operation control, or a second return operation control is performed. The normal control is performed when it is determined that the electric riding lawn mower 10 is not in the stuck state. The control unit 38 controls the wheel speeds of the left drive wheel 14L and the right drive wheel 14R based on the amount of operation of each operation lever 18. The normal control may be performed when it is determined that neither the left drive wheel 14L nor the right drive wheel 14R is in the slip state.

The first return operation control and the second return operation control are performed when it is determined that the electric riding lawn mower 10 is in the stuck state. The first return operation control and the second return operation control are controls for causing the electric riding lawn mower 10 to perform a return operation for getting out of the stuck state of the electric riding lawn mower 10. The first return operation control and the second return operation control may be performed when it is determined that the left drive wheel 14L or the right drive wheel 14R is in the slip state. The first return operation control and the second return operation control can be regarded as controls for causing the electric riding lawn mower 10 to perform a return operation for getting out of the slip state of the left drive wheel 14L or the right drive wheel 14R.

In the first return operation control, the control unit 38 controls the wheel speeds of the left drive wheel 14L and the right drive wheel 14R based on the amount of operation of each operation lever 18, as in the normal control. However, in the first return operation control, the wheel speeds of the left drive wheel 14L and the right drive wheel 14R are controlled in a manner so that the electric riding lawn mower 10 is caused to repeat stopping and starting. By stopping the rotation of the left drive wheel 14L and the right drive wheel 14R in order to stop the electric riding lawn mower 10, the frictional coefficient between the left drive wheel 14L/the right drive wheel 14R and the ground increases. This suppresses slipping of the left drive wheel 14L and the right drive wheel 14R and thus increases the likelihood that the electric riding lawn mower 10 will get out of the stuck state.

In the second return operation control, the control unit 38 controls the wheel speeds of the left drive wheel 14L and the right drive wheel 14R in a manner so that the electric riding lawn mower 10 travels straight, regardless of the amount of operation of each operation lever 18. For causing the electric riding lawn mower 10 to perform pivot

turning, one of the left drive wheel 14L and the right drive wheel 14R is stopped, or the left drive wheel 14L and the right drive wheel 14R are rotated in opposite directions. On the other hand, for causing the electric riding lawn mower 10 to move straight, the left drive wheel 14L and the right drive wheel 14R are rotated in the same direction. By causing the electric riding lawn mower 10 to travel straight, the drive force for moving the electric riding lawn mower 10 is distributed to both the left drive wheel 14L and the right drive wheel 14R. As a result, slipping of the left drive wheel 14L and the right drive wheel 14R are suppressed, and the possibility that the electric riding lawn mower 10 will get out of the stuck state is increased.

In step S21, the control unit 38 determines whether or not the slip duration time is equal to or greater the fifth threshold value. If the slip duration time is equal to or greater than the fifth threshold value (step S21: YES), the process proceeds to step S23. If the slip duration time is less than the fifth threshold value (step S21: NO), the process proceeds to step S22.

As described above, when the slip duration time is equal to or greater than the fifth threshold, the determination unit 36 determines that the electric riding lawn mower 10 is in the stuck state. Therefore, when it is determined in step S21 that the slip duration time is equal to or greater than the fifth threshold value, it can be determined that the electric riding lawn mower 10 is in the stuck state. When the electric riding lawn mower 10 is in the stuck state, the left drive wheel 14L or the right drive wheel 14R is in the slip state. Therefore, when it is determined in step S21 that the slip duration time is equal to or greater than the fifth threshold value, it can be determined that the left drive wheel 14L or the right drive wheel 14R is in the slip state.

In step S22, the control unit 38 executes the normal control. Thereafter, the drive control is terminated.

In step S23, the control unit 38 determines whether or not the number of times the first return operation control is executed (which will be hereinafter referred to as the number of times of the first return operation control) is equal to or less than a sixth threshold value. When the number of times of the first return operation control is equal to or less than the sixth threshold value (step S23: YES), the process proceeds to step S24. When the number of times of the first return operation control is greater than the sixth threshold value (step S23: NO), the process proceeds to step S25.

In step S24, the control unit 38 executes the first return operation control. Thereafter, the drive control is terminated.

In step S25, the control unit 38 determines whether or not the number of times the second return operation control is executed (which will be hereinafter referred to as the

number of times of the second return operation control) is equal to or less than a seventh threshold value. When the number of times of the second return operation control is equal to or less than the seventh threshold value (step S25: YES), the process proceeds to step S26. When the number of times of the second return operation control is greater than the seventh threshold value (step S25: NO), the process proceeds to step S27.

In step S26, the control unit 38 executes the second return operation control. Thereafter, the drive control is terminated.

In step S27, the control unit 38 controls a notification unit (not shown) to notify the user that the electric riding lawn mower 10 is in the stuck state. The notification unit is, for example, a display unit, a buzzer, or the like mounted on the electric riding lawn mower 10. When the electric riding lawn mower 10 is in the automatic operation and the user is thus not on the electric riding lawn mower 10, information indicating that the electric riding lawn mower 10 is in the stuck state may be transmitted to a terminal carried by the user.

### Operation and Effects

In the vehicle control device 26 of the embodiment, it is determined whether or not the left drive wheel 14L or the right drive wheel 14R is in the slip state, based on the comparison between the actual yaw rate and the first threshold value and the comparison between the calculated

yaw rate and the second threshold value. This makes it possible to determine with high accuracy whether or not the left drive wheel 14L or the right drive wheel 14R is in the slip state.

In the vehicle control device 26 of the embodiment, when the absolute value of the actual yaw rate is less than the first threshold value and the absolute value of the calculated yaw rate is equal to or greater than the second threshold value, the determination unit 36 determines that the left drive wheel 14L or the right drive wheel 14R has got into the slip state. When a relatively large slip occurs in the left drive wheel 14L or the right drive wheel 14R, the determination unit 36 can determine that the slip state of the left drive wheel 14L or the right drive wheel 14R has started.

In the vehicle control device 26 of the embodiment, when the left drive wheel 14L or the right drive wheel 14R is in the slip state, the determination unit 36 determines that the slip state of the left drive wheel 14L or the right drive wheel 14R is continuing in a case that the absolute value of the actual yaw rate is less than the first threshold value and the absolute value of the calculated yaw rate is equal to or greater than the third threshold value. The third threshold value is a value smaller than the second threshold value. After it is determined that the left drive wheel 14L or the right drive wheel 14R has begun to slip, even if a relatively small slip occurs in the left drive wheel 14L or the right drive wheel 14R, it is determined that the slip state is still continuing.

In the vehicle control device 26 of the embodiment, when the number of times of slip determination is equal to or greater than the fourth threshold value, the absolute value of the actual yaw rate is less than the first threshold value, and the absolute value of the calculated yaw rate is equal to or greater than the third threshold value, the determination unit 36 determines that the slip state of the left drive wheel 14L or the right drive wheel 14R is continuing. When a relatively large slip continuously occurs in the left drive wheel 14L or the right drive wheel 14R, it is determined that the left drive wheel 14L or the right drive wheel 14R is in the slip state. This makes it possible to improve the accuracy of determination of the slip state of the left drive wheel 14L or the right drive wheel 14R.

In the vehicle control device 26 of the embodiment, when the slip duration time is equal to or greater than the fifth threshold value, it is determined that the electric riding lawn mower 10 is in the stuck state. This improves the accuracy of determining of the stuck state of the electric riding lawn mower 10.

In the vehicle control device 26 of the embodiment, when it is determined that the left drive wheel 14L or the right drive wheel 14R is in the slip state, or when it is determined that the electric riding lawn mower 10 is in the stuck state, the return operation control is performed. As a result, the left drive wheel 14L or the right drive wheel 14R can get out of the slip state. Further, the electric riding lawn mower 10 can get out of the stuck state.

The following Supplementary Notes are further disclosed in relation to the above embodiment.

### Supplementary Note 1

The slip-state determination method according to the present disclosure is a method for determining the slip state of the drive wheel (14L, 14R) provided in the mobile working machine (10) and which is driven by the drive motor (16L, 16R), the method including: acquiring the yaw rate of the mobile working machine, as the actual yaw rate, by using the yaw rate detection unit (40); calculating the yaw rate of the mobile working machine, as the calculated yaw rate, based on the wheel speed of the drive wheel; and determining whether or not the drive wheel is in the slip state based on the comparison between the actual yaw rate and the first threshold value and the comparison between the calculated yaw rate and the second threshold value. This makes it possible to determine with high accuracy whether or not the drive wheel is in the slip state.

### Supplementary Note 2

In the slip-state determination method according to Supplementary Note 1, in the case that the absolute value of the actual yaw rate is less than the first threshold value and the absolute value of the calculated yaw rate is equal to or greater than the second threshold value, it may be determined that the drive wheel is in the slip state.

### Supplementary Note 3

In the slip-state determination method according to Supplementary Note 2, in the case that, after it has been determined that the drive wheel is in the slip state, the absolute value of the actual yaw rate is less than the first threshold value and the absolute value of the calculated yaw rate is equal to or greater than the third threshold value that is less than the second threshold value, it may be determined that the slip state of the drive wheel is continuing. This makes it possible to determine with high accuracy that the slip state of the drive wheel is continuing.

### Supplementary Note 4

In the slip-state determination method according to Supplementary Note 3, whether or not the drive wheel is in the slip state may be periodically determined at predetermined time intervals, the number of times of determination may be counted, the number of times of determination being the number of times that the drive wheel is determined to be in the slip state, and in the case that the number of times of determination is equal to or greater than the fourth threshold value, the absolute value of the actual yaw rate is less than the first threshold value, and the absolute value of the calculated yaw rate is equal to or greater than the third threshold value, it may be determined that the slip state of the drive wheel is continuing.

### Supplementary Note 5

In the slip-state determination method according to Supplementary Note 4, in the case that, before the number of times of determination reaches the fourth threshold value, it is determined that the drive wheel is not in the slip state, the number of times of determination may be reset to zero.

### Supplementary Note 6

In the slip-state determination method according to any one of Supplementary Notes 1 to 5, in the case that it is determined that the drive wheel is in the slip state, the time period during which the slip state of the drive wheel continues may be measured as the slip duration time, and it may be determined whether or not the mobile working machine is in the stuck state, based on the comparison between the slip duration time and the fifth threshold value. This makes it possible to determine whether or not the mobile working machine is in the stuck state, with high accuracy.

### Supplementary Note 7

In the slip-state determination method according to any one of Supplementary Notes 1 to 5, in the case that it is determined that the drive wheel is in the slip state, the mobile working machine may be caused to perform the return operation for getting out of the slip state. This increases the possibility that the drive wheel will get out of the slip state.

### Supplementary Note 8

In the slip-state determination method according to Supplementary Note 6, in the case that it is determined that the mobile working machine is in the stuck state, the mobile working machine may be caused to perform the return operation for getting out of the stuck state. This makes it possible to increase the possibility that the mobile working machine will get out of the stuck state.

### Supplementary Note 9

The stuck-state determination method of the present disclosure is the stuck-state determination method for determining the stuck state of the mobile working machine including the drive wheel driven by the drive motor, the method including: acquiring the yaw rate of the mobile working machine, as the actual yaw rate, by using the yaw rate detection unit; calculating the yaw rate of the mobile working machine, as the calculated yaw rate, based on the wheel speed of the drive wheel; measuring the duration time which is the time period during which the state in which the absolute value of the actual yaw rate is less than the first threshold value and the absolute value of the calculated yaw rate is equal to or greater than the second threshold value continues; and determining whether or not the mobile working machine is in the stuck state, based on the comparison between the duration time and the fifth threshold value.

### Supplementary Note 10

The program according to the present disclosure is a program that causes a computer to execute the slip-state determination method for determining the slip state of the drive wheel provided in the mobile working machine and which is driven by the drive motor, the program causing the computer to: acquire the yaw rate of the mobile working machine, as the actual yaw rate, by using the yaw rate detection unit; calculate the yaw rate of the mobile working machine, as the calculated yaw rate, based on the wheel speed of the drive wheel; and determine whether or not the drive wheel is in the slip state, based on the comparison between the actual yaw rate and the first threshold value and the comparison between the calculated yaw rate and the second threshold value.

### Supplementary Note 11

The program of the present disclosure is a program that causes a computer to execute the stuck-state determination method for determining the stuck state of the mobile working machine including the drive wheel driven by the drive motor, the program causing the computer to: acquire the yaw rate of the mobile working machine, as the actual yaw rate, by using the yaw rate detection unit; calculate the yaw rate of the mobile working machine, as the calculated yaw rate, based on the wheel speed of the drive wheel; measure the duration time which is the time period during which a state in which the absolute value of the actual yaw rate is less than the first threshold value and the absolute value of the calculated yaw rate is equal to or greater than the second threshold value continues; and determine whether or not the mobile working machine is in the stuck state, based on the comparison between the duration time and the fifth threshold value.

### Supplementary Note 12

The non-transitory computer-readable storage medium of the present disclosure stores the program according to Supplementary Note 10 or 11.

### Supplementary Note 13

The slip-state determination device (26) of the present disclosure is the slip-state determination device that determines the slip state of the drive wheel provided in the mobile working machine and which is driven by the drive motor, the slip-state determination device including: the actual yaw rate acquisition unit (32) configured to acquire the yaw rate of the mobile working machine, as the actual yaw rate, by using the yaw rate detection unit; the yaw rate calculation unit (34) configured to calculate the yaw rate of the mobile working machine, as the calculated yaw rate, based on the wheel speed of the drive wheel; and the determination unit (36) configured to determine whether or not the drive wheel is in the slip state, based on the comparison between the absolute value of the actual yaw rate and the first threshold value and the comparison between the absolute value of the calculated yaw rate and the second threshold value.

### Supplementary Note 14

In the slip-state determination device according to Supplementary Note 13, in the case that the absolute value of the actual yaw rate is less than the first threshold value and the absolute value of the calculated yaw rate is equal to or greater than the second threshold value, the determination unit may determine that the drive wheel is in the slip state.

### Supplementary Note 15

In the slip-state determination device according to Supplementary Note 14, in the case that, after it has been determined that the drive wheel is in the slip state, the absolute value of the actual yaw rate is less than the first threshold value and the absolute value of the calculated yaw rate is equal to or greater than the third threshold value that is less than the second threshold value, the determination unit may determine that the slip state of the drive wheel is continuing.

### Supplementary Note 16

In the slip-state determination device according to Supplementary Note 15, the determination unit may periodically determine whether or not the drive wheel is in the slip state at predetermined time intervals; the determination unit may count the number of times of determination, the number of times of determination being the number of times that the drive wheel is determined to be in the slip state; and the determination unit may determine that the slip state of the drive wheel is continuing, in the case that the number of times of

determination is equal to or greater than the fourth threshold value, the absolute value of the actual yaw rate is less than the first threshold value, and the absolute value of the calculated yaw rate is equal to or greater than the third threshold value.

### Supplementary Note 17

In the slip-state determination device according to Supplementary Note 16, in the case that, before the number of times of determination reaches the fourth threshold value, it is determined that the drive wheel is not in the slip state, the determination unit may reset the number of times of determination to zero.

### Supplementary Note 18

In the slip-state determination device according to any one of Supplementary Notes 13 to 17, in the case that it is determined that the drive wheel is in the slip state, the determination unit may measure, as the slip duration time, the time period during which the slip state of the drive wheel continues; and the determination unit may determine whether or not the mobile working machine is in the stuck state, based on the comparison between the slip duration time and the fifth threshold value.

### Supplementary Note 19

The slip-state determination device according to any one of Supplementary Notes 13 to 17 may further include the control unit (38) configured to, in the case that it is determined that the drive wheel is in the slip state, cause

the mobile working machine to perform the return operation for getting out of the slip state.

### SUPPLEMENTARY NOTE 20

The slip-state determination device according to Supplementary Note 18 may further include a control unit configured to, in the case that it is determined that the mobile working machine is in the stuck state, cause the mobile working machine to perform the return operation for getting out of the stuck state.

### Supplementary Note 21

The stuck-state determination device of the present disclosure is a stuck-state determination device for determining the stuck state of the mobile working machine including the drive wheel driven by the drive motor, the stuck-state determination device including: the actual yaw rate acquisition unit configured to acquire the yaw rate of the mobile working machine, as the actual yaw rate, by using the yaw rate detection unit; the yaw rate calculation unit configured to calculate the yaw rate of the mobile working machine, as the calculated yaw rate, based on the wheel speed of the drive wheel; and the determination unit configured to measure the duration time which is the time period during which a state in which the absolute value of the actual yaw rate is less than the first threshold value and the absolute value of the calculated yaw rate is equal to or greater than the second threshold value continues, and determine whether or not the mobile working machine is in the stuck state, based on the comparison between the duration time and the fifth threshold value.

Although the present disclosure has been described in detail, the present disclosure is not necessarily limited to each of the aforementioned embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

What is claimed is:

1. A slip-state determination method for determining a slip state of a drive wheel provided in a mobile working machine and which is driven by a drive motor, the method being executed by one or more processors, the method comprising:
acquiring a yaw rate of the mobile working machine, as an actual yaw rate;
calculating the yaw rate of the mobile working machine, as a calculated yaw rate, based on a wheel speed of the drive wheel; and
determining whether or not the drive wheel is in the slip state, based on a comparison between the actual yaw rate and a first threshold value and a comparison between the calculated yaw rate and a second threshold value.

2. The slip-state determination method according to claim 1, wherein
in a case that an absolute value of the actual yaw rate is less than the first threshold value and an absolute value of the calculated yaw rate is equal to or greater than the second threshold value, it is determined that the drive wheel is in the slip state.

3. The slip-state determination method according to claim 2, wherein
in a case that, after it has been determined that the drive wheel is in the slip state, the absolute value of the actual yaw rate is less than the first threshold value and the absolute value of the calculated yaw rate is equal to or greater than a third threshold value that is less than the second threshold value, it is determined that the slip state of the drive wheel is continuing.

4. The slip-state determination method according to claim 3, wherein
whether or not the drive wheel is in the slip state is periodically determined at predetermined time intervals,
a number of times of determination is counted, the number of times of determination being a number of times that the drive wheel is determined to be in the slip state, and
in a case that the number of times of determination is equal to or greater than a fourth threshold value, the absolute value of the actual yaw rate is less than the first threshold value, and the absolute value of the calculated yaw rate is equal to or greater than the third threshold value, it is determined that the slip state of the drive wheel is continuing.

5. The slip-state determination method according to claim 4, wherein
in a case that, before the number of times of determination reaches the fourth threshold value, it is determined that the drive wheel is not in the slip state, the number of times of determination is reset to zero.

6. The slip-state determination method according to claim 1, wherein
in a case that it is determined that the drive wheel is in the slip state, a time period during which the slip state of the drive wheel continues is measured as a slip duration time, and
it is determined whether or not the mobile working machine is in a stuck state, based on a comparison between the slip duration time and a fifth threshold value.

7. The slip-state determination method according to claim 1, wherein
in a case that it is determined that the drive wheel is in the slip state, the mobile working machine is caused to perform a return operation for getting out of the slip state.

8. The slip-state determination method according to claim 6, wherein
in a case that it is determined that the mobile working machine is in the stuck state, the mobile working machine is caused to perform a return operation for getting out of the stuck state.

9. A stuck-state determination method for determining a stuck state of a mobile working machine including a drive wheel driven by a drive motor, the method being executed by one or more processors, the method comprising:
acquiring a yaw rate of the mobile working machine, as an actual yaw rate;
calculating the yaw rate of the mobile working machine, as a calculated yaw rate, based on a wheel speed of the drive wheel;
measuring a duration time, the duration time being a time period during which a state in which an absolute value of the actual yaw rate is less than a first threshold value and an absolute value of the calculated yaw rate is equal to or greater than a second threshold value continues; and
determining whether or not the mobile working machine is in the stuck state, based on a comparison between the duration time and a fifth threshold value.

10. A non-transitory computer-readable storage medium storing a program that causes a computer to execute a slip-state determination method for determining a slip state of a drive wheel provided in a mobile working machine and which is driven by a drive motor,
the program causing the computer to:
acquire a yaw rate of the mobile working machine, as an actual yaw rate;
calculate the yaw rate of the mobile working machine, as a calculated yaw rate, based on a wheel speed of the drive wheel; and
determine whether or not the drive wheel is in the slip state, based on a comparison between the actual yaw rate and a first threshold value and a comparison between the calculated yaw rate and a second threshold value.

11. A non-transitory computer-readable storage medium storing a program that causes a computer to execute a stuck-state determination method for determining a stuck state of a mobile working machine including a drive wheel driven by a drive motor,
the program causing the computer to:
acquire a yaw rate of the mobile working machine, as an actual yaw rate;
calculate the yaw rate of the mobile working machine, as a calculated yaw rate, based on a wheel speed of the drive wheel;
measure a duration time, the duration time being a time period during which a state in which an absolute value of the actual yaw rate is less than a first threshold value and an absolute value of the calculated yaw rate is equal to or greater than a second threshold value continues; and
determine whether or not the mobile working machine is in the stuck state, based on a comparison between the duration time and a fifth threshold value.

12. A slip-state determination device for determining a slip state of a drive wheel provided in a mobile working machine and which is driven by a drive motor, the slip-state determination device comprising:
one or more processors that execute computer-executable instructions stored in a memory, wherein the one or more processors execute the computer-executable instructions to cause the slip-state determination device to:
acquire a yaw rate of the mobile working machine, as an actual yaw rate;
calculate the yaw rate of the mobile working machine, as a calculated yaw rate, based on a wheel speed of the drive wheel; and
determine whether or not the drive wheel is in the slip state, based on a comparison between an absolute value of the actual yaw rate and a first threshold value and a comparison between an absolute value of the calculated yaw rate and a second threshold value.

13. The slip-state determination device according to claim 12, wherein
in a case that the absolute value of the actual yaw rate is less than the first threshold value and the absolute value of the calculated yaw rate is equal to or greater than the second threshold value, the one or more processors cause the slip-state determination device to determine that the drive wheel is in the slip state.

14. The slip-state determination device according to claim 13, wherein
in a case that, after it has been determined that the drive wheel is in the slip state, the absolute value of the actual yaw rate is less than the first threshold value and the absolute value of the calculated yaw rate is equal to or greater than a third threshold value that is less than the second threshold value, the one or more processors cause the slip-state determination device to determine that the slip state of the drive wheel is continuing.

15. The slip-state determination device according to claim 14, wherein
the one or more processors cause the slip-state determination device to:
periodically determine whether or not the drive wheel is in the slip state at predetermined time intervals;
count a number of times of determination, the number of times of determination being a number of times that the drive wheel is determined to be in the slip state; and
determine that the slip state of the drive wheel is continuing, in a case that the number of times of determination is equal to or greater than a fourth threshold value, the absolute value of the actual yaw rate is less than the first threshold value, and the absolute value of the calculated yaw rate is equal to or greater than the third threshold value.

16. The slip-state determination device according to claim 15, wherein
in a case that, before the number of times of determination reaches the fourth threshold value, it is determined that the drive wheel is not in the slip state, the one or more processors cause the slip-state determination device to reset the number of times of determination to zero.

17. The slip-state determination device according to claim 12, wherein
the one or more processors cause the slip-state determination device to:
in a case that it is determined that the drive wheel is in the slip state, measure, as a slip duration time, a time period during which the slip state of the drive wheel continues; and
determine whether or not the mobile working machine is in a stuck state, based on a comparison between the slip duration time and a fifth threshold value.

18. The slip-state determination device according to claim 12, wherein
in a case that it is determined that the drive wheel is in the slip state, the one or more processors cause the mobile working machine to perform a return operation for getting out of the slip state.

19. The slip-state determination device according to claim 17, wherein
in a case that it is determined that the mobile working machine is in the stuck state, the one or more processors cause the mobile working machine to perform a return operation for getting out of the stuck state.

20. A stuck-state determination device for determining a stuck state of a mobile working machine including a drive wheel driven by a drive motor, the stuck-state determination device comprising:
one or more processors that execute computer-executable instructions stored in a memory, wherein the one or more processors execute the computer-executable instructions to cause the stuck-state determination device to:
acquire a yaw rate of the mobile working machine, as an actual yaw rate;
calculate the yaw rate of the mobile working machine, as a calculated yaw rate, based on a wheel speed of the drive wheel;
measure a duration time, the duration time being a time period during which a state in which an absolute value of the actual yaw rate is less than a first threshold value and an absolute value of the calculated yaw rate is equal to or greater than a second threshold value continues; and
determine whether or not the mobile working machine is in the stuck state, based on a comparison between the duration time and a fifth threshold value.
